(19) United States
(12) Patent Application Publication
(10) Pub. No.: US 2006/0091618 A1
(43) Pub. Date: May 4, 2006

(54) Hydro mechanical clamping device

(76) Inventor: Niclas Rosberg, Norrkoping (SE)

Correspondence Address: STITES & HARBISON PLLC, 1199 NORTH FAIRFAX STREET, SUITE 900, ALEXANDRIA, VA, 22314, US

(21) Appl. No.: 10/517,205

(22) PCT Filed: Jul. 17, 2003
(86) PCT No.: PCT/SE03/01222

§ 371 Date: Dec. 8, 2004

(30) Foreign Application Priority Data
Jul. 17, 2002 (SE) 0202246-5

(51) Int. Cl. B23B 31/30

(52) U.S. Cl. 279/4.01; 279/4.07

(57) ABSTRACT

Hydromechanical clamping device, in particular in the form of a chuck or a mandrel, preferably intended to be, with one end thereof, mounted in a machining device, such as a drilling machine, a milling machine, a lathe machine etc., and with the other end to releasably hold a tool, such as a drill, a milling tool, a rotary saw blade, a grinding roll a work piece, a transition element etc., the clamping device comprising an inner sleeve and an outer sleeve. The inner sleeve and the outer sleeve encloses at least one chamber in which a clamping means in the shape of an annular piston is enclosed, which piston by means of hydraulically operating means is displaceable in the axial direction, wherein the piston and the inner sleeve and/or the outer sleeve have interacting conical surfaces which at axial displacement of the piston in one direction cause radial compression of the inner sleeve for clamping the tool. At axial displacement of the piston in the other direction the tool is released.

### TECHNICAL FIELD

The present invention generally relates to a hydro mechanical clamping device which with one end thereof is intended to be mounted in a rotary or possibly a non-rotary machining device, such as a drilling machine, a milling machine, a lathe machine etc., and with the other end is intended to releasably hold a shaft tool, a work piece, a transition element, a hub or a similar object, such as a drill, a milling tool, a rotary saw blade, a grinding roll etc. according to the preamble of claims 1 and 8.

### BACKGROUND OF THE INVENTION

Clamping devices of this kind are known in various embodiments. Such known clamping devices may consist of chucks that are formed as hydraulic clamp bushings in the form of a double walled sleeve comprising a thin inner wall and an all around extending pressure gap which is filled with a hydraulic pressure medium which, upon pressurization, provides a radial compression and pressing inwards the thin inner wall, and thereby a clamping of the tool shaft in the bushing. Such hydraulic clamp bushings are, however, intended for lighter machining.

WO98/32563 A1 discloses another embodiment of chucks for shaft tools where the chuck consists of a relatively thin inner sleeve arranged so that is can be radially compressed towards the tool shaft, and a substantially rigid outer sleeve which is axially displaceable on the inner sleeve, and where the inner sleeve and the outer sleeve have co-operating conical surfaces which, upon displacement of the outer sleeve on the inner sleeve, provides a radially inwardly directed compression of the inner sleeve. First press means are used for mounting and clamping the tool and second press means are used for releasing the joint.

The clamping device may further be embodied as a mandrel. Such known mandrels are generally formed so that exchangeable tools are secured in the direction of rotation of the mandrel by means of mechanical means such as keys, splines or similar means, or by a heat press joint, and, against axial displacement, by means of nuts or screws. Such mechanical locking means do not give a perfect precision and circular path of the tool, and it may often be difficult to provide a perfect centering, which in turn may give rise to unbalance and vibrations in the working tool and the machining device due to the unbalance. It may also often be a difficult and time consuming operation to release the joint between the mandrel and the tools, especially in the case where the tools are mounted by heat press joints.

WO98/32562 A1 discloses a mandrel embodied as a hydraulic clamp bushing with a relatively thin outer wall and radially inside said outer wall an all around extending pressure medium gap filled with a hydraulic pressure medium which, when being pressurized, makes said outer wall to expand radially outwards and thereby centering and clamp tools on the clamp body.

Apart from the above mentioned problems/disadvantages with existing chucks and mandrels the rigidity against flexing is a common problem for tool chucks and mandrels, i.e. at the use of hard working tools vibrations might arise due to too low rigidity against flexing in the tool mount in the machine. The vibrations might give rise to a rough machined surface.

WO84/04367 A1 discloses a hydraulic frictional coupling for connecting two shafts or a shaft and a hub. The coupling comprises an annular chamber with an annular piston that at an axial displacement causes radial expansion or compression of the chamber for achieving a junction. WO84/04367 A1 does not relate to chucks or mandrels, and does not relate to an arrangement for achieving a high flexural rigidity.

There is thus a need for chucks and mandrels that are both cheap and of a simple construction and that at the same time have a high rigidity against flexing for making precision machining with hard working tools possible.

### AIM OF THE INVENTION AND MOST IMPORTANT FEATURES

The object of the present invention is to provide a hydromechanical clamping device that solves the above problem.

This object is achieved by a hydromechanical clamping device as set forth in claims 1 and 8.

A hydromechanical clamping device, in particular in the form of a chuck or mandrel, preferably intended to be, with one end (4) thereof, mounted in a machining device, such as a drilling machine, a milling machine, a lathe machine etc., and with the other end to releasably hold a shaft tool, such as a drill, a milling tool, a rotary saw blade, a grinding roll, a work piece, a transition element, a hub or a similar object, etc., comprising an inner sleeve and an outer sleeve. The inner sleeve and the outer sleeve encloses at least one chamber in which an annular piston is enclosed, which piston by means of hydraulically operating means is displaceable in the axial direction, wherein the piston and the inner sleeve or the outer sleeve have interacting conical surfaces which at axial displacement of the piston in one direction cause radial compression of the inner sleeve or radial expansion of the outer sleeve for clamping the shaft tool. At axial displacement of the piston in the other direction releases the shaft tool. This has the advantage that a strong tool mount with very good centering and balancing of the tool is obtained at the same time as the arrangement provides a strongly clamped tool. This further has the advantage that force reception via the outer sleeve is obtained, by which the diameter of the outer sleeve allows a good moment reception and thereby a high rigidity against flexing.

The hydraulic means may include a pressurization chamber arranged at one end of the piston, and a relief chamber at the other end of the piston. The chambers are capable of being filled and pressurized by a hydraulic pressure medium. This has the advantage that a simple mounting and dismantling process is obtained.

The inner sleeve and the outer sleeve may be joined together by welding, threading, soldering, gluing or with a combination thereof. This has the advantage that a strong junction between the inner sleeve and the outer sleeve is obtained, which allows a high force reception.

A sealing means, preferably in the shape of a sealing ring may be arranged between the piston and the outer sleeve. This has the advantage that shunting of hydraulic fluid between the ends of the piston may be avoided.

The sealing means may be arranged closer to the pressurization side of the piston than to the relief side. This has the advantage that a dismantling pressure lower than the mounting pressure may be used.

The part intended for clamping a tool may be integrated with the part intended for mounting in a machining device. This has the advantage that a higher flexural rigidity may be achieved.

This further has the advantage that a compact and handy chuck is obtained.

### BRIEF DESCRIPTION OF THE DRAWINGS

The invention will now be described closer with guidance of embodiments and with reference to the accompanying drawings, in which:

FIGS. 1, 3 and 4 show embodiments of a chuck according to the present invention.

FIG. 2 shows the force flow in an embodiment of the present invention.

FIG. 5 shows a mandrel according to the present invention.

FIG. 6 shows a spindle according to the present invention.

### DETAILED DESCRIPTION OF PREFERRED EMBODIMENTS OF THE INVENTION

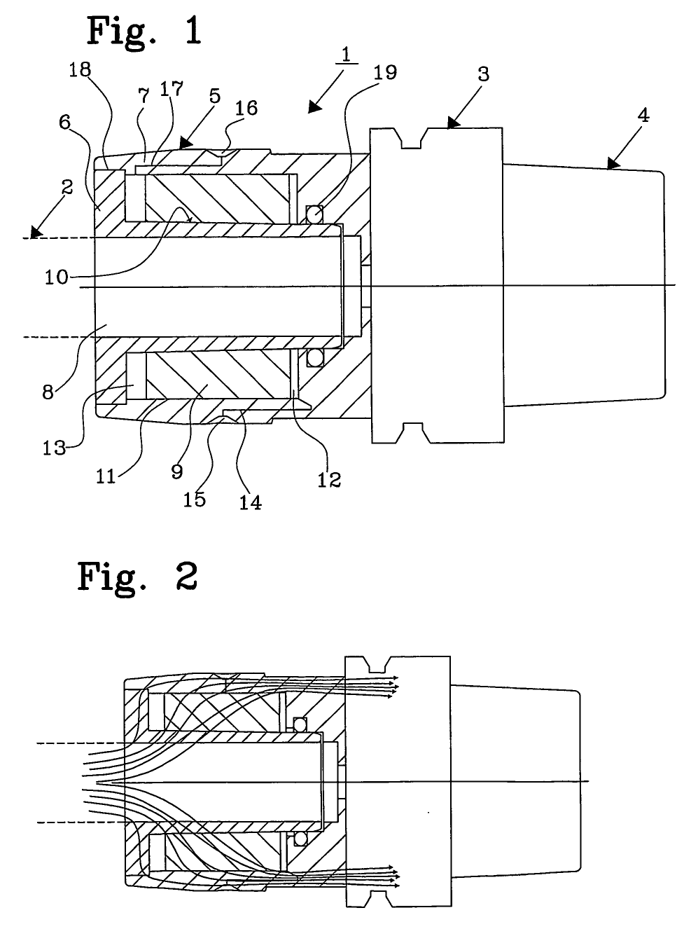

FIG. 1 shows a hydromechanical chuck according to the invention in a partly cut open condition.

The chuck 1 shown in the figure consists of a transition part 3, for instance in the form of a V-shaped flange, a chuck cone 4 for connection in a corresponding conical cavity of a rotary or non-rotary machining device, and a clamp body 5 for releasable connection of a shaft tool 2 and for securing the same in the clamp body 5. The transition part 3, the cone 4 and the clamp body 5 form a composed unit. The cone 4 may be formed with a cooling medium passageway (not illustrated) leading to the mounting bore 8.

The transition part 3 with the chuck cone 4 is of a type known in the art and need not be described in detail. The cone 4 is adapted for being introduced in a corresponding, conical cavity of a rotating machining device, such as a drilling machine, a lathe machine, a milling machine or a similar machine. It is of course also possible to form the chuck cone as an integral part of the machining device, whereby only the clamp body constitutes the inventional part of the device. This is illustrated in FIG. 6, which shows a machine spindle 60 with an integrated clamp body 61 according to the present invention. The figure also shows that the spindle is journalled in bearings 62 and 63.

In order to make it possible to connect a shaft tool 2, the clamp body is formed with an inner sleeve 6 and with an outer sleeve 7. The inner sleeve 6 and the outer sleeve 7 enclose a chamber in which an annular piston 9 is arranged.

The inner sleeve 6 has relatively thin walls for making a deformation of these walls possible, especially a radial compression of the walls towards the shaft of a tool 2 so that the tool is clamped in the chuck. If so desired, different types of sleeves (for instance reduction sleeves) may be introduced between the shaft of the tool 2 and the inner sleeve 6.

The outer sleeve 7 is not noticeable deformed at the clamping of a tool 2 in the inner sleeve 6. The inner sleeve 6 and the annular piston 9 have interacting peripheral conical surfaces 10, the conicity of which is such that the interacting conical surface 7 is self locking, i.e. after pressurization the surfaces may not slide on each other by themselves. The inner sleeve 6 has an axial mounting bore 8 for the shaft of the tool 2. The cone 4 may be formed with a cooling medium passageway (not shown) extending to the mounting bore 8.

In the chamber 11 there is on each side of the piston 9, respectively, a pressure chamber. A first pressure chamber 12 at the inner end of the piston for causing a displacement of the piston 9 outwards, i.e. in the clamping direction, along the inner sleeve 6 to thereby cause a compression of the inner sleeve 6 and consequently a clamping of the tool 2. At the outer end of the piston 9 there is a second pressure chamber 13 for causing a displacement of the piston 9 in an opposite direction and thereby a release of the tool. The pressure chambers 12 and 13 are arranged to be pressurized with any suitable kind of hydraulic pressure medium. The first pressure chamber 12 leads via a first channel 14 to a first connection 15, and the other pressure chamber 13 is reached via a second connection 16 and a channel 17. The connections 15 and 16, respectively, are suitably connected to an external pressurization pump (not shown).

For sealing the pressure chamber 12 a sealing ring 19 seals between the inner and outer sleeve.

When a shaft tool is to be mounted, the tool 2 is introduced into the axial bore 8 of the inner sleeve. Thereafter the chamber 12 is pressurized with hydraulic medium of a certain predetermined pressure from the connection 15 via the pressure channel 14, said pressure in the chamber 12 causes a displacement of the piston 9 in a locking direction, i.e. outwards on the inner sleeve 6, whereby the walls of the inner sleeve 6 are compressed radially, and the tool 2 is centered and clamped in the chuck by the inner sleeve 6. Since the conical surfaces 10 are self locking there is no risk that the clamp joint will become released. The mounting bore 8 need not be cylindrical but it can be adapted to the shape of the shaft that is to be clamp connected. Thus, the cross section of the bore 8 may be polygonal, square, octagonal etc.

When releasing the tool 2 the pressure chamber 13 is instead pressurized through the connection 16 via the channel 17, whereby the piston 9 is pressed towards the inner end of the chuck, as is shown in FIG. 1, whereby the inner sleeve 6 expands and regains its original shape at the same time the tool 2 becomes released.

The pressure chambers 12 and 13 are not pressurized during operation, the clamping of the tool is entirely mechanical. The hydraulic pressurization is only performed during mounting and dismantling of the tool 2.

The inner sleeve 6 and the outer sleeve 7 are in the common contact surface 18 welded together, threaded together, soldered together, glued together or joined with a combination thereof. Further, the outer sleeve 7 may be integrated with the transition part 3 and/or the cone 4. Alternatively, the outer sleeve 7 may be welded or threaded on to the transition part 3 and/or the cone 4.

I previously known devices the transmission of force is received via an inner sleeve. The construction of the present invention results in that received forces mostly is received through the outer sleeve. This is illustrated with arrows in FIG. 2. Thanks to the larger diameter of the outer sleeve it is capable of receiving considerably larger forces than an inner sleeve, which leads to that the tool 2 may work under a very high load without the arising of vibrations giving grooves in cut surfaces.

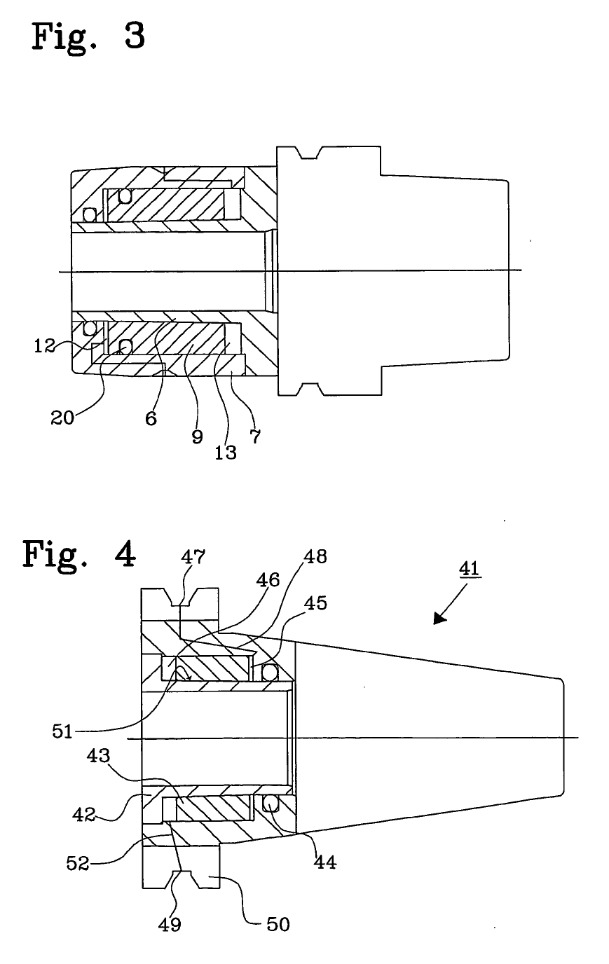

In FIG. 3 an alternative embodiment of the device in FIG. 1 is shown. In FIG. 3 the device has been complemented with a sealing ring 20 on the outer side of the piston 9. Since the pressure goes from high at the inner side of the inner sleeve 6 to zero at the outer side of the outer sleeve 7 this sealing ring is particularly necessary in those cases where the outer sleeve is relatively thin. In this case the pressure on the outer side of the piston is so low that shunting of hydraulic fluid from one pressure chamber to the other might occur, which in turn has the result that mounting/dismantling can not be carried out. In the cases where the outer sleeve consists of a thicker sleeve, sufficient pressure on the outer side of the piston might be obtained so that a correct mounting/dismantling may be carried out.

The sealing ring has a further function. As is shown in FIG. 3, the sealing ring 20 is mounted closer to the pressure chamber 12 for mounting that the pressure chamber 13 for dismantling. This has the effect that the friction between the piston 9 and the outer housing 7 is higher during mounting than during dismantling since a shorter part of the piston 9 can be lubricated by the hydraulic medium along the outer sleeve 7. A further effect that is obtained is that since the friction of the piston against the outer sleeve is lower during dismantling than during mounting, the pressure needed during dismantling is lower than the corresponding pressure that has been used during mounting. There is thus no risk that the necessary dismantling pressure is higher than an available pressure, which otherwise might be the case when a dismantling pressure equal to or higher than the mounting pressure is needed.

In FIG. 4, a further embodiment of the present invention is shown. In the embodiment shown in FIG. 4 the clamp body 5 in FIG. 1 is integrated in the chuck cone. As in FIG. 1 the clamp body comprises an inner sleeve 42 and a piston 43 with interacting conical surfaces 51, the conicity of which is such that the interacting conical surface is self locking. The outer sleeve is arranged as an integrated part of the chuck cone. As in FIG. 1 the outer and inner sleeve are sealed against each other by a sealing ring 44. The piston 43 is controlled via pressure chambers for mounting 45 and dismantling 46, respectively. During mounting the pressure chamber 45 is pressurized with hydraulic medium of some predetermined pressure from the connection 47, which in this case is situated on the V-shaped transition part 50, via the pressure channel 48, whereby the pressure in chamber 45 causes a displacement of the piston 43 in a locking direction.

At dismantling of a tool the pressure chamber 46 is pressurized via the connection 49, also this situated on the V-shaped transition part 50, via the channel 52, whereby the piston 43 as has been described is pressed in the direction towards the inner end of the chuck, whereby the inner radius of the inner sleeve 42 expands and regains its original form and at the same time the tool is released.

The chuck 41 shown in FIG. 4 makes even higher force reception possible and thereby even better rigidity against flexing for a working tool. This embodiment also makes it possible to have the tool mount within the machine bearings, which even further improves the ability to receive forces.

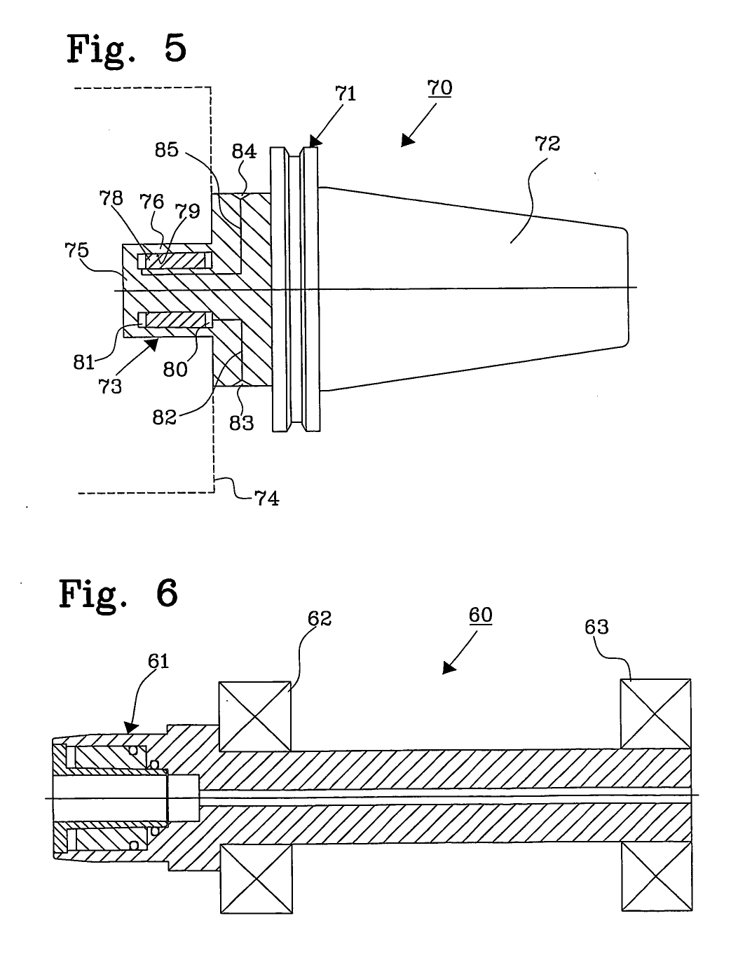

FIG. 5 shows yet another embodiment of the present invention. FIG. 5 shows a partly cut open hydromechanical mandrel 70 according to the invention. The mandrel 70 consists of a transition part 71, a cone 72 and a clamp body 73 for releasable connection and securing of a tool 74, such as a hub. The mandrel 70 further consists of an inner sleeve 75 and an outer sleeve 76 enclosing a chamber in which an annular piston 78 is arranged.

In this embodiment the outer sleeve 76 has relatively thin walls for making a deformation of these walls possible, especially a radial expansion of the walls towards a tool 74 so that the tool is clamped on to the mandrel.

The outer sleeve 76 and the annular piston 78 have interacting peripheral conical surfaces 79, the conicity of which are such that the interacting conical surface is self locking.

As in the embodiment shown in FIG. 1, there is in the chamber, on each side of the piston 78, respectively, a pressure chamber. A first pressure chamber 80 at the inner end of the piston for causing a displacement of the piston 78 outwards, i.e. in the clamping direction, along the outer sleeve 76 to thereby cause a radial expansion of the outer sleeve 76 and consequently a clamping of the tool. At the outer end of the piston 78 there is a second pressure chamber 81 for causing a displacement of the piston 78 in an opposite direction and thereby a release of the tool. The pressure chambers are arranged to be pressurized with any suitable kind of hydraulic pressure medium. The first pressure chamber 80 leads via a first channel 82 to a first connection 83, and the other pressure chamber 81 is reached via a second connection 84 and a second channel 85.

When a tool 74 is to be mounted, the tool 74 is put onto the outer sleeve 76. Thereafter the chamber 80 is pressurized with hydraulic medium of a certain predetermined pressure from the connection 83 via the pressure channel 82, whereby the pressure in the chamber 80 causes a displacement of the piston 78 in a locking direction, i.e. outwards along the outer sleeve 76, whereby the walls of the outer sleeve 76 expands radially, and the tool 74 is centered and clamped on to the expanding outer sleeve 76. Since the conical surfaces 79 are self locking there is no risk that the clamp joint will become released.

When releasing the tool 74 the pressure chamber 81 is pressurized through the connection 84 via the channel 85, whereby the piston 78 is pressed towards the inner end of the mandrel, whereby the outer sleeve 76 expands and regains its original shape, and at the same time the tool 74 becomes released.

As before, the pressure chambers 80 and 81 are not pressurized during operation, the clamping of the tool is entirely mechanical.

As in the case with the chuck also the mandrel may be formed such that it constitutes an integrated part of a machining device.

The conicity of the piston and inner sleeve and outer sleeve, respectively, may of course be such that the diameter of the conical surfaces decreases either towards the inner end of the piston or towards the outer end of the piston. This is also illustrated in FIGS. 2 and 3 where the diameter of the conical surfaces decreases in different directions. In an alternative, not shown embodiment the chuck/mandrel may be formed with a plurality of chambers in the axial direction. Each chamber, respectively, may then be provided with an annular piston. This embodiment has the advantage that an even stronger clamping of a tool may be achieved since each piston contributes to the clamping.

The chuck/mandrel can be reused several times. It is of course also possible to keep the tool clamped in the chuck/mandrel and to remove the entire chuck/mandrel from the machining device and to reserve the combined unit of chuck/mandrel and tool for subsequent working with the same tool.

1. Hydromechanical clamping device, in particular in the form of a chuck, preferably intended to be, with one end thereof, mounted in a machining device, and with the other end to releasably hold a shaft tool, the clamping device comprising an inner sleeve with an axial bore for receiving the shaft of the shaft tool, and a clamping means, characterized in that the inner sleeve and an outer sleeve encloses at least one chamber in which a clamping means in the shape of an annular piston is enclosed, which piston by means of hydraulically operating means is displaceable in the axial direction, wherein the piston and the inner sleeve have interacting conical surfaces which at axial displacement of the piston in one direction cause radial compression of the inner sleeve for clamping the shaft tool, and that axial displacement of the piston in the other direction causes relief of the inner sleeve for releasing the shaft tool.

2. Clamping device according to claim 1,
characterized in that the hydraulic means include a pressurization chamber arranged at one end of the piston, and a relief chamber at the other end of the piston, which chambers are capable of being filled and pressurized by a hydraulic pressure medium.

3. Clamping device according to claim 1,
characterized in that the interacting conical surfaces have a conicity that is self locking.

4. Clamping device according to claim 1, characterized in that the inner sleeve and the outer sleeve are joined together by welding, threading, soldering, gluing or with a combination thereof.

5. Clamping device according to claim 1, characterized in that a sealing means, preferably in the shape of a sealing ring, is arranged between the piston and the outer sleeve.

6. Clamping device according to claim 5,
characterized in that the sealing means is arranged closer to the pressurization side of the piston than to the relief side.

7. Clamping device according to claim 1, characterized in that the part intended for clamping a tool is integrated with the part intended for mounting in a machining device.

8. Clamping device according to claim 1, characterized in that the clamping device comprises two or more axial chambers, wherein each chamber encloses an annular piston.

9. Hydromechanical clamping device, in particular in the form of a mandrel, preferably intended to be, with one end thereof, mounted in a machining device, and with the other end to releasably hold a tool, the clamping device comprising an inner sleeve and a clamping means,
characterized in that the inner sleeve and an outer sleeve encloses at least one chamber in which a clamping means in the shape of an annular piston is enclosed, which piston by means of hydraulically operating means is displaceable in axial direction, wherein the piston and the outer sleeve have interacting conical surfaces that at axial displacement of the piston in one direction cause radial expansion of the outer sleeve for clamping the tool, and that axial displacement of the piston in the other direction causes relief of the outer sleeve for releasing the tool.

10. Clamping device according to claim 9,
characterized in that the hydraulic means include a pressurization chamber arranged at one end of the piston, and a relief chamber at the other end of the piston, which chambers are capable of being filled and pressurized by a hydraulic pressure medium.

11. Clamping device according to claim 9, characterized in that the clamping device comprises two or more axial chambers, wherein each chamber encloses an annular piston.
